(19) United States
(12) Patent Application Publication
(10) Pub. No.: US 2007/0267445 A1
(43) Pub. Date: Nov. 22, 2007

(54) Mouthwash dispenser

(76) Inventor: Clifford Mark Fogelberg, San Diego, CA (US)

Correspondence Address: Clifford Mark Fogelberg, 1960 GRAND AVE #19, SAN DIEGO, CA, 92109-4507, US

(21) Appl. No.: 11/434,774

(22) Filed: May 17, 2006

(51) Int. Cl. B67D 5/06

(52) U.S. Cl. 222/185.1

(57) ABSTRACT

This invention is to give people a more convenient and pleasant way of dispensing mouthwash. It is a dispenser on four legs with a spout and is currently unavailable on the market.

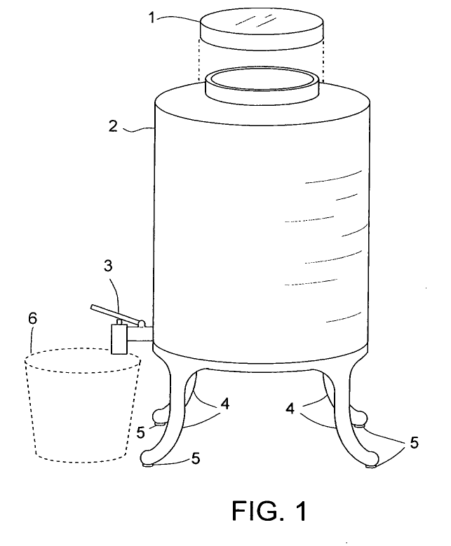

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE OR COMPUTER PROGRAM LISTING COMPACT DISC APPENDIX

Not applicable

### BACKROUND OF THE INVENTION

To dispense in a clean more attractive manner, rather than the problem of constant opening and closing of current dispenser.

### BRIEF SUMMARY OF THE INVENTION

To dispense mouthwash in the usable area cleanly and efficiently the object is to eliminate the constant reopening and is much quicker and convenient.

Item-1 Lid for dispenser removable.

Item-2 Cylindrical container for the mouthwash.

Item-3 Spout for the dispenser.

Item-4 Legs for the dispenser, four.

Item-5 Rubberized pads for the base support of the invention.

1. A dispenser as described in specifications.
A dispenser to dispense mouthwash.
One made of plastic.
Raised on four legs.
It will have a spout.
You can put either a cup or glass under the spout, or a Dixie cup or similar item.

2. A dispenser for mouthwash.
As described in specification.
One made of plastic or glass.
Raised on four legs.
It will have a spout as in specification but may be a safety-spout.
It will dispense into receptacle of owners choosing.
